(19) United States
(12) Patent Application Publication
(10) Pub. No.: US 2006/0251130 A1
(43) Pub. Date: Nov. 9, 2006

(54) Method and apparatus for dynamic time-warping of speech

(76) Inventors: Steven Craig Greer, Rowlett, TX (US); Adrian Boariu, Irving, TX (US)

Correspondence Address: DITTHAVONG & MORI, P.C., Suite A, 10507 Braddock Road, Fairfax, VA, 22032, US

(21) Appl. No.: 11/402,124

(22) Filed: Apr. 11, 2006

Related U.S. Application Data
(60) Provisional application No. 60/670,166, filed on Apr. 11, 2005.

(51) Int. Cl. H04J 3/06

(52) U.S. Cl. 370/508

(57) ABSTRACT

An approach is provided for time-warping of speech. A condition that introduces delay in a communication system is determined to exist. Dynamic time-warping of a voice frame is performed in response to the determined condition for playout to a user.

### RELATED APPLICATIONS

This application claims the benefit of the earlier filing date under 35 U.S.C. §119(e) of U.S. Provisional Application Ser. No. 60/670,166 filed Apr. 11, 2005, entitled “Method and Apparatus for Supporting Transmission of Packetized Voice Streams Using Dynamic Time-warping of Speech,” the entirety of which is incorporated by reference.

### FIELD OF THE INVENTION

Various exemplary embodiments of the invention relate generally to communications.

### BACKGROUND

Radio communication systems, such as cellular systems (e.g., spread spectrum systems (such as Code Division Multiple Access (CDMA) networks), or Time Division Multiple Access (TDMA) networks), provide users with the convenience of mobility along with a rich set of services and features. This convenience has spawned significant adoption by an ever growing number of consumers as an accepted mode of communication for business and personal uses. Given the competitive landscape, great expense and effort have been invested in ensuring that these users are provided with the best experience. One area of concern is network delays, such as the delay associated with handoffs. A handoff is a process in which a mobile moves from cell to cell through a coverage area while maintaining a communication connection. A “hard” handoff involves discontinuity of the channel (i.e., “break-before-make”), while a “soft” handoff provides continuity of the channel throughout the process (i.e., “make-before-break”). The delay problem is more acute in a Voice over Internet Protocol (VOIP) environment, as speech playout can be severely distorted by late or dropped packets.

Therefore, there is a need for an approach for minimizing the effects of delay in the playout of speech.

### SUMMARY OF SOME EXEMPLARY EMBODIMENTS

These and other needs are addressed by various embodiments of the invention, in which an approach is presented for time-warping of speech in a communication system.

According to one aspect of an embodiment of the invention, a method comprises determining whether a condition exists that introduces delay in a communication system; and dynamically time-warping of a voice frame in response to the determined condition for playout to a user.

According to another aspect of an embodiment of the invention, an apparatus comprises a decision module configured to determine whether a condition exists that introduces delay in a communication system. The apparatus also comprises a speech decoder configured to dynamically time-warp a voice frame in response to the determined condition for playout to a user.

According to another aspect of an embodiment of the invention, a method comprises receiving a time-warping parameter over a communication system from a terminal for time-warping of speech, wherein the time-warping parameter is determined by the terminal based on channel condition of the communication or loading of the communication system. The terminal dynamically adjusts playout of the speech in response to the channel condition or the loading. The method also comprises modifying scheduling of voice frames representing speech according to the time-warping parameter.

According to another aspect of an embodiment of the invention, an apparatus comprises a transceiver configured to receive a time-warping parameter over a communication system from a terminal for time-warping of speech, wherein the time-warping parameter is determined by the terminal based on channel condition of the communication or loading of the communication system. The terminal dynamically adjusts playout of the speech in response to the channel condition or the loading. Also, the apparatus comprises a scheduler configured to schedule voice frames representing speech for transmission to the terminal, wherein scheduling of voice frames is modified according to the time-warping parameter.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG: 1 is a diagram of a slewing mechanism deployed in a terminal, in accordance with an embodiment of the invention;

FIG. 2 is a flowchart of a process for dynamic time-warping of speech, in accordance with an embodiment of the invention;

FIG. 3 is a flowchart of a process for dynamically adjusting the playout buffer in the terminal of FIG. 1, in accordance with an embodiment of the invention;

FIG. 4 is a flowchart of a process for a base transceiver station to inform a terminal to adjust buffer size, in accordance with an embodiment of the invention;

FIGS. 5A and 5B are flowcharts of processes for monitoring system parameters to adjust speech delay, according to various embodiments of the invention;

FIG. 6 is a flowchart of a process for signaling in the system of FIG. 1 to negotiate slewing parameters, in accordance with an embodiment of the invention;

FIGS. 7A and 7B are flowcharts of processes for minimizing delay during transmission of voice frames on the uplink, according to various embodiments of the invention;

FIG. 8 is a diagram of hardware that can be used to implement various embodiments of the invention;

FIGS. 9A and 9B are diagrams of different cellular mobile phone systems capable of supporting various embodiments of the invention;

FIG. 10 is a diagram of exemplary components of a mobile station capable of operating in the systems of FIGS. 9A and 9B, according to an embodiment of the invention; and

FIG. 11 is a diagram of an enterprise network capable of supporting the processes described herein, according to an embodiment of the invention.

### DESCRIPTION OF THE PREFERRED EMBODIMENT

These and other needs are addressed by the embodiments of the invention, in which an approach is presented for providing minimizing the effects of delay by time-warping speech. “Speech” is used herein to denote any audio information, including voice sounds, tones, musical tones, etc.

An apparatus, method, and software for time-warping of speech are disclosed. In the following description, for the purposes of explanation, numerous specific details are set forth in order to provide a thorough understanding of the invention. It is apparent, however, to one skilled in the art that the invention may be practiced without these specific details or with an equivalent arrangement. In other instances, well-known structures and devices are shown in block diagram form in order to avoid unnecessarily obscuring the embodiments of the invention.

Although the invention, according to various embodiments, is discussed with respect to a radio communication network (such as a cellular system), it is recognized by one of ordinary skill in the art that the embodiments of the invention have applicability to any type of communication systems, including wired systems. Additionally, the various embodiments of the invention are explained in the context of compensating for handover delay (particularly hard handoffs) in Code Division Multiple Access (CDMA) systems (e.g., 3GPP2 CDMA2000) in support of Voice over Internet Protocol (VoIP) services, it is recognized by one of ordinary skill in the art that the slewing mechanism can be applied to any network environment capable of transporting packetized voice.

FIG. 1 is a diagram of a slewing mechanism deployed in a terminal, in accordance with an embodiment of the invention. For the purposes of illustration, the slewing (or time-warping) mechanism, according to one embodiment, is explained in the context of a radio communication system 100 (e.g., spread spectrum cellular system), whereby an access terminal 101 communicates with a base transceiver station (BTS) 103. The terminal 101, in one embodiment, can be a mobile. As used herein, the terms “mobile,” “mobile station,” “mobile device” or “unit” are synonymous. Although the various embodiments of the invention describe the mobile as a handset, it is contemplated that any mobile device with voice functionality can be used (e.g., a combined Personal Digital Assistant (PDA) and cellular phone).

In modern cellular networks, speech communication over the air interface is conveyed through circuit-switched links, or channels that are reserved for the duration of the call. Both the CDMA2000 1xEV-DV (Evolutionary/Data and Voice) and 1X EV-DO (Evolutionary/Data Only) air interface standards specify a packet data channel for use in transporting packets of data over the air interface on the forward link and the reverse link. While these packet data channels have been optimized for non-real time data communications, there is growing interest in using them for speech communications. A wireless communication system (e.g., system 100) may be designed to provide various types of services. These services may include point-to-point services, or dedicated services such as voice and packet data, whereby data is transmitted from a transmission source (e.g., a base station) to a specific recipient terminal. Such services may also include point-to-multipoint (i.e., multicast) services, or broadcast services, whereby data is transmitted from a transmission source to a number of recipient terminals.

Code Division Multiple Access (CDMA) circuit-switched connections perform a soft-handoff to avoid any break in speech communications when a handoff occurs. This is not possible with the packet data channel of either CDMA2000 1xEV-DV (Evolutionary/Data and Voice) or 1X EV-DO (Evolutionary/Data Only). Traditional systems require the use of buffer management while. delaying the playout, creating an unacceptably long delay in a two-way communications path. It is noted that this technique does not alter the playout rate of the speech, which is kept constant. Such delay poses significant challenges for deployment of Voice over Internet Protocol (VoIP) technology over cellular networks, which is sensitive to network latency. Further, it is recognized that another problem with VoIP over the packet data channel is the delay experienced during two-way communications. Bad channel conditions and heavy load of the system require a significant delay be built into the communication path, thus degrading the quality of conversation.

Contrary to the soft handoff technique used in CDMA for circuit-switched speech communications, hard handoff is used with a forward traffic channel (F-TCH). The break in communications when undergoing a hard handoff with the F-TCH is approximately 200-250 ms, and during this time the status of the mobile is transferred from the old serving base transceiver station (BTS) to the new serving BTS. In a 1xEV-DO system, the delay value in switching from one BTS to another is broadcast to all users in the sector using the parameter “SOFT_HANDOFF_DELAY.” Regardless, this interruption in speech communications is undesirable from the point of view of speech quality.

Various embodiments of the invention use speech-slewing technique in order to minimize or eliminate the gap that may occur in the speech communication when, for example, the terminal 101 is in hard handover. In one embodiment, a known or standard technique of slewing (or time-warping) the playout of received speech is used to increase the size of a buffer of speech that is played to the listener while hard handoff occurs. The slewing (time-warping) mechanism changes the default playout rate of a voice frame. This operation can require additional signal processing that can include specific operations such as up-sampling or down-sampling, interpolation, filtering, etc. In an exemplary embodiment, the speech module (speech decoder), for each 20 ms encoded speech frame input to it, plays out more than 20 ms of speech. The increase buffer size allows the system to compensate for the effects of hard handoff (gap in speech communications). The playout of speech is slewed in the opposite direction (sped up) after the hard handoff to return the communications delay back to its normal state.

As shown in FIG. 1, the terminal 101 includes a queue (or buffer) analyzer 105 that interfaces with a buffer 107 and operates with a decision module 109 (denoted as “decision maker”) to perform buffer management compensation for handoff mitigation and communications delay mitigation. As used herein, the buffer 107 can be referred to as a playout buffer or a jitter buffer. The voice frames that are stored in the buffer 107 are fed to a speech decoder 111, which outputs to a speaker 113 for generating sound waves.

As seen, within the BTS 103, there is a scheduler 115 operating in conjunction with a drop timer 117 for determining when a packet (e.g., voice frame) should be dropped from a playout buffer 119. That is, the scheduler 115 uses a time limit (drop-timer) value that a packet is allowed to remain in the buffer 119 before is considered dropped. The larger the drop-timer value is, the larger the system capacity; however, the playout buffer size increases resulting in an increase of the end-to-end delay, an effect that is undesirable.

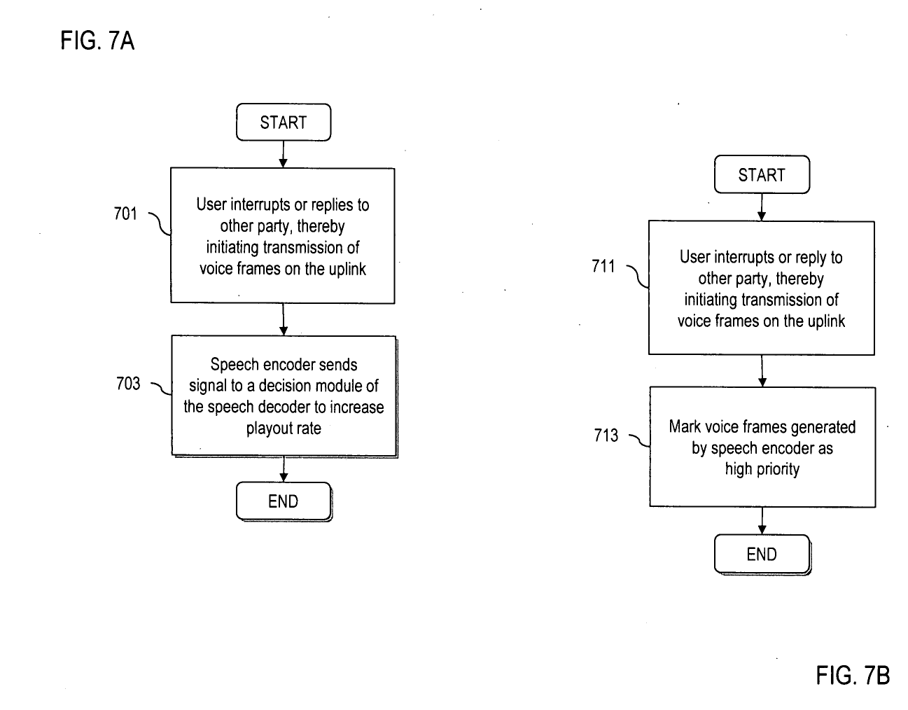

In another embodiment, the delay can be further minimized in the situation whereby a user of the terminal 101 wishes to interrupt or reply to another user over the uplink. Under this scenario, a speech encoder 121 of the terminal 101 can communicate with the speech decoder 111 to increase the playout rate. This process is more fully described with respect to FIG. 7A.

As for the operation of the terminal 101, the queue analyzer 105 analyzes the voice frames that arrive in the buffer 107. In an exemplary embodiment, the queue analyzer 105 uses a sliding window as input for the analysis. The queue analyzer 105 also provides the decision maker 109 with relevant information about the buffer 101—i.e., buffer information including, for example, queue length (size), voice frame type (in which the shaded blocks represent speech frames and non-shaded representing silence frames), a detection of the beginning of voice inactivity indicating that the other end user is not speaking, etc. Thus, the queue analyzer 105 provides a quick description of the voice frames before they are decoded.

In addition to the information from the queue analyzer 105, the decision maker 109 can be supplied with other information (“decision parameters”), such as handover request, handover duration, BTS's channel conditions, BTS drop-timer value, information about user starting reply or interrupting, etc. One task of the decision maker 109 is to mark the voice frames in the buffer as being speech or silence frames. This can assist the speech decoder 111 to playout the speech and silence voice frames at different speeds, as speech frames are more sensitive to playout speed variations relative to the silence frames. Also, the decision maker 109 can duplicate or insert silence voice frames in order to increase the queue length (size), if deemed necessary.

The decision maker 109 can also inform the speech decoder 111 of how fast the decoder 111 should play out the buffered speech. If the channel conditions are bad and/or there is a handover request, the speech decoder 111 may be commanded to play the buffer at a slower speed indicated by a negative (“−”) sign. On the other hand, if the channel conditions are good and/or the terminal 101 wants to reduce the end-to-end delay, the speech decoder 111 is commanded to play the buffer at a faster speed—indicated by a positive (“+”) sign. When operating in the steady-state mode, the playout speed is set to default value, which is zero “0”.

The speech decoder 111 converts the encoded speech frames to speech. The decoder 111 includes logic for the actual slewing capability. In this example, such capability can include different slewing rates for active speech and silence frames. Usually, the active speech tolerates a lower speed variation (time warp) relative to a default or baseline value.

In the example of FIG. 1, the queue analyzer 105, decision maker 109, and speech decoder 111 are explained as separate components. However, it is contemplated that these functional modules can be implemented as one or more components in various combinations of functions. The implementation can vary, while preserving the same overall functionality.

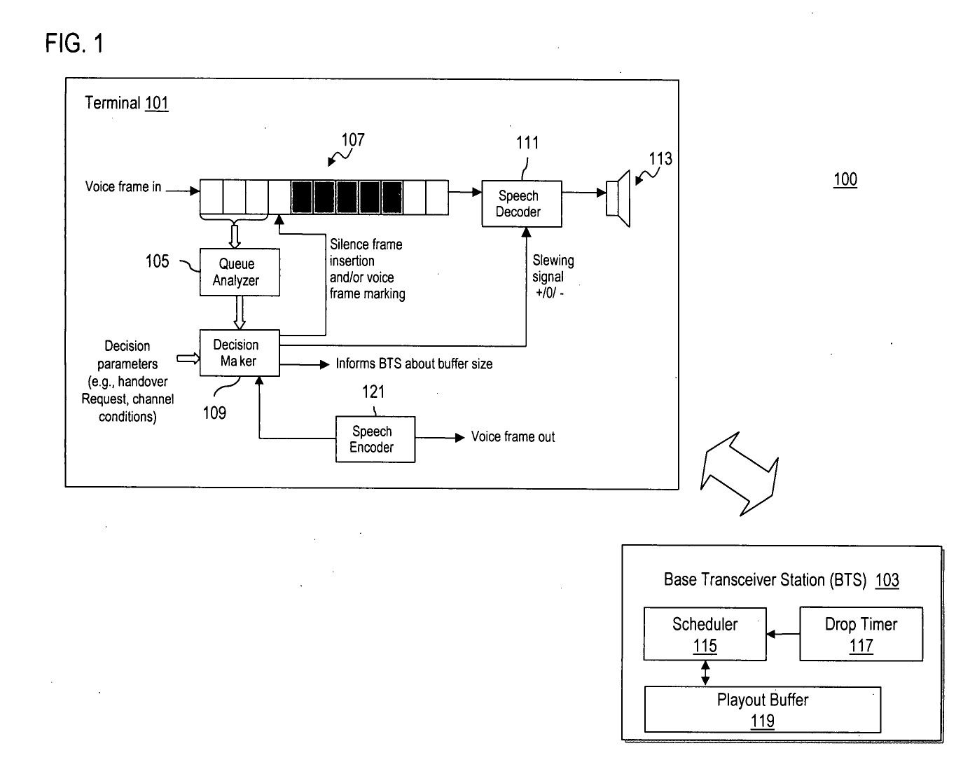

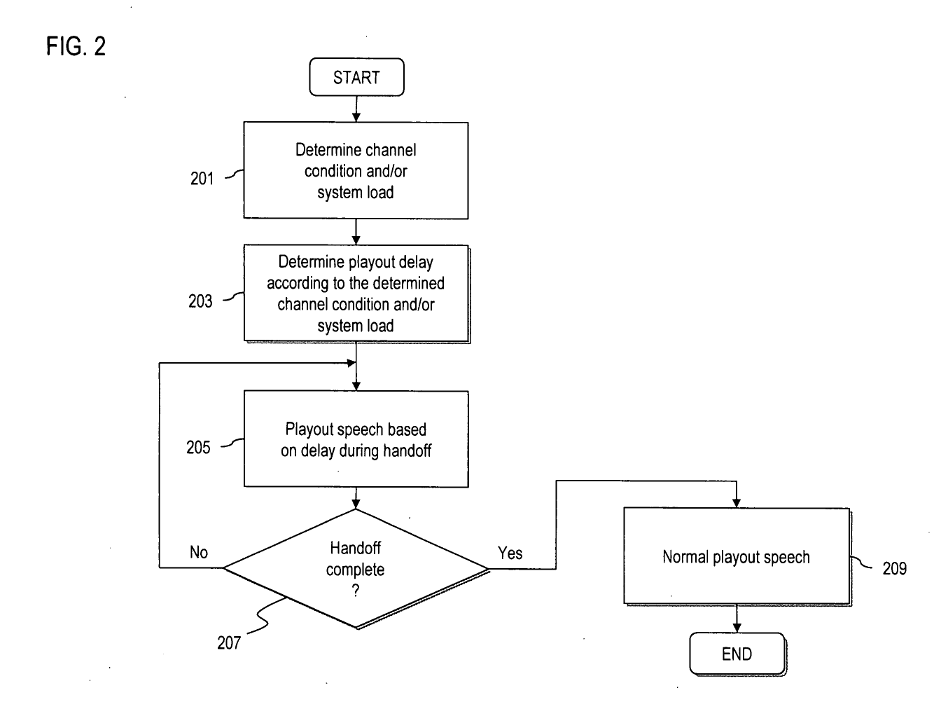

In other embodiments, the slewing mechanism of FIG. 1, which provides delay mitigation due to channel and/or system load, can be applied to communication nodes within a wired communication network. The time-warping process is further described in FIGS. 2-7, according to various embodiments of the invention.

FIG. 2 is a flowchart of a process for dynamic time-warping of speech, in accordance with an embodiment of the invention. As mentioned, various embodiments of the invention optimize the delay a user experiences under normal two-way conversation as a function of channel and/or system load conditions. Thus, users experiencing good channel conditions (e.g., strong signal strength, etc.) and/or light system loading can then enjoy a smaller communications delay, while users in poor channel conditions and/or heavy system loading have their delay increased in an attempt to alleviate the effects of buffer underflow. Therefore, as the channel the user experiences changes, so does the delay the user experiences.

In step 201, the channel condition and/or system load is determined. Next, based on the channel condition and/or system load, the slewing mechanism (e.g., per the speech decoder 111) determines the playout delay, as in step 203. The speech decoder 111 then plays out, as in step 205, the speech according to the determined playout delay—i.e., time-warping or slewing the speech playout. Under this scenario, the time-warping is performed during a handoff process (e.g., hard handoff) wherein delay is prominent.

The terminal 101 can decide to perform the handover based on, for example, the pilot channel strengths (i.e., signal strength) from the BTSs. Because of the handoff, the terminal 101 is aware of the fact that there will be an “outage” period of duration given by a signalling message, e.g., SOFT_HANDOFF_DELAY. To compensate for this outage (at least partially), the terminal 101 switches to slewing operation mode in advance of handover, thereby slowing down the playout of voice at the decoder 111. Consequently, there is an artificial increase of the buffer length from the playout point of view. Whenever the terminal 101 considers opportune, the terminal 101 can begin the handover procedure. The following exemplary events or conditions that can trigger the actual handover, taken alone or in combination depending on their priority, include the following: (1) the buffer length is large enough to ensure a seamless handover procedure; (2) the channel of the serving BTS degrades rapidly; or (3) the terminal 101 detects that the other end user has no voice activity. The process of FIG. 2 can be applied to address the handover problem associated with deploying Voice over Internet Protocol (VoIP) over the air interface using packet data channels by providing a way to manage the delay associated with VoIP over a cellular packet data channel.

In step 207, it is determined whether the handoff is complete. If the handoff is completed, the playout rate is returned to the “normal” rate before the handoff process (as in step 209).

The slewing process is dynamic in nature, as to adapt to changing channel conditions and system loads, as next explained. Also, the above process may be applied generally to mitigate any cause of delays that would affect the user experience.

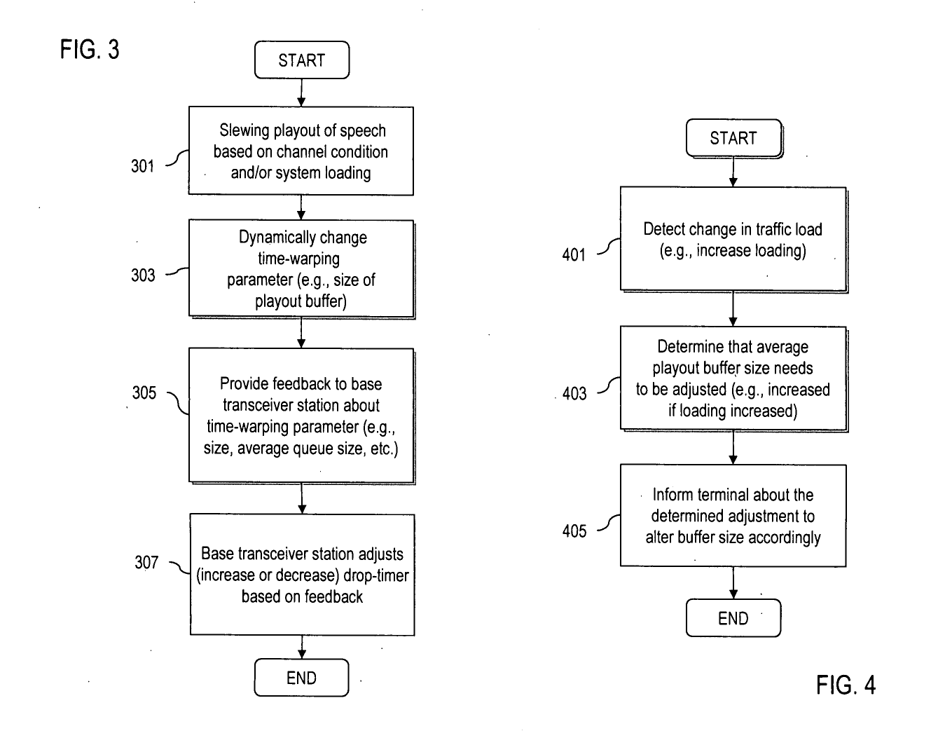

FIG. 3 is a flowchart of a process for dynamically adjusting the playout buffer in the terminal of FIG. 1, in accordance with an embodiment of the invention. In step 301, the speech decoder 111 time-warps the speech based on the channel condition and/or system loading, which is accomplished by dynamically changing one or more slewing or time-warping parameters—e.g., size of the playout buffer 107 (step 303). Next, in step 305, the decision maker 109 generates information about the changed time-warping parameter, which in this case is information about the buffer 107, to provide as feedback to the base transceiver station 103. In turn, the base transceiver station 103 adjusts (increases or decreases, as appropriate) the drop-timer value for the drop timer 117 based on the feedback.

With this process, slewing the playout of speech is used to dynamically change, for example, the length (or size) of the playout buffer 107, thereby managing the delay that the user experiences as a function of the state of the channel and/or system loading. Users with good channel conditions and/or light system loading can then enjoy a smaller communications delay because the scheduler 115 delivers the data (e.g., packetized voice, or media streams) reliably, while users experiencing poor channel conditions and/or heavy system loading may have their delay increased due to an unreliable channel in an attempt to alleviate the effects of buffer underflow.

Also, when the terminal 101 experiences, for example, bad channel conditions, the terminal 101 can inform the BTS 103 that its average playout buffer size has been adjusted (in this case, decreased). Consequently, this permits the BTS scheduler 115 to increase the drop-timer value for that particular terminal 101.

FIG. 4 is a flowchart of a process for a base transceiver station to inform a terminal to adjust buffer size, in accordance with an embodiment of the invention. In this example, the base transceiver station 103 detects, as in step 401, a change in traffic load, for example, increase in traffic load. The base transceiver station 103 then determines, per step 403, that the average size of its playout buffer 119 requires adjustment. In step 405, the base transceiver station 103 informs the terminal 101 about the adjustment to increase the buffer size accordingly. According to one embodiment of the invention, a communication link (signalling) can be dedicated between the scheduler 113 of the base transceiver station 103 and the terminal 101 to provide the feedback information about the average buffer playout size and/or the BTS average queue.

Under the process of FIG. 4, if the base transceiver station 103 experiences an increase in traffic load (which translates into an increase in the average buffer size), the base transceiver station 103 can inform the terminal 101 about this increase in loading so that the terminal 101 can take appropriate action—i.e., increase the average playout buffer size and/or perform some slewing in order to compensate for additional delays.

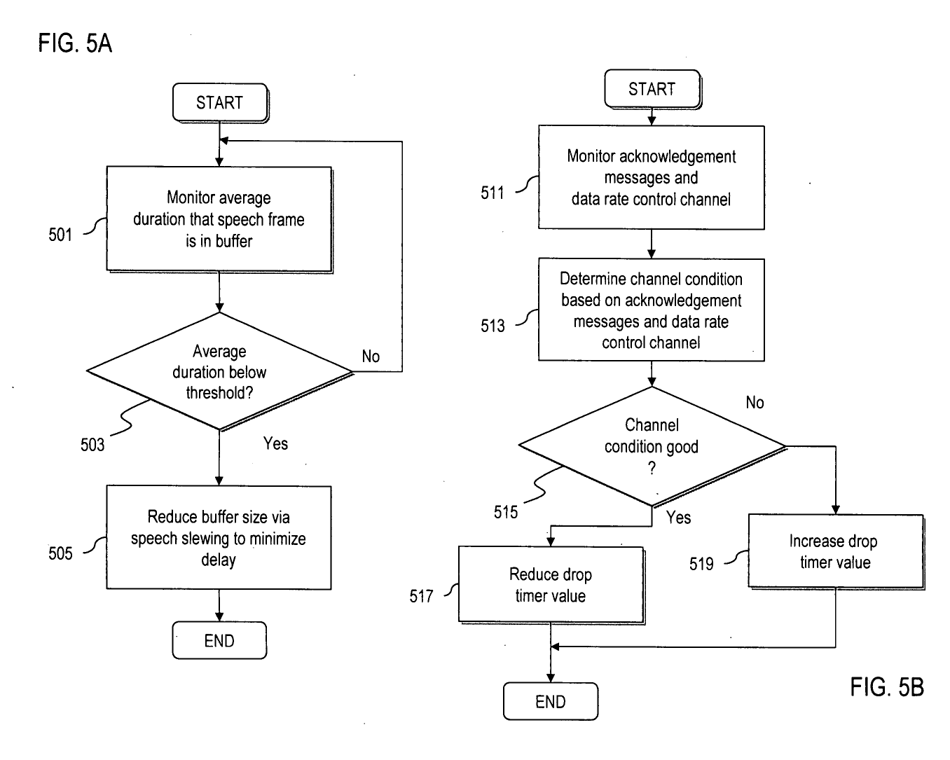

FIGS. 5A and 5B are flowcharts of processes for monitoring system parameters to adjust speech delay, according to various embodiments of the invention. Under the scenario of FIG. 5A, the terminal 101 can, on its own, monitor the average time a speech frame is spending in the jitter buffer 107 (step 501). If the average duration is below a configurable threshold (per step 503), the terminal 101 can reduce, as in step 505, the size of the jitter buffer 107 via speech slewing, thereby reducing the delay in the forward link.

In addition, the base transceiver station 103 can monitor acknowledgement messages (ACK/NAK's (Acknowledgements and Negative Acknowledgements)) from the terminal 101 as well as the data rate control (DRC) channel to determine the channel condition the terminal 101 is experiencing (per steps 511 and 513). In other words, if a higher data rate is utilized, this would be indicative of a good channel condition, while a low data rate would indicate poor conditions. If the channel condition is good (as determined in step 515), the drop timer can be reduced, as in step 517. If the channel condition is bad, the drop timer can be increased, per step 519.

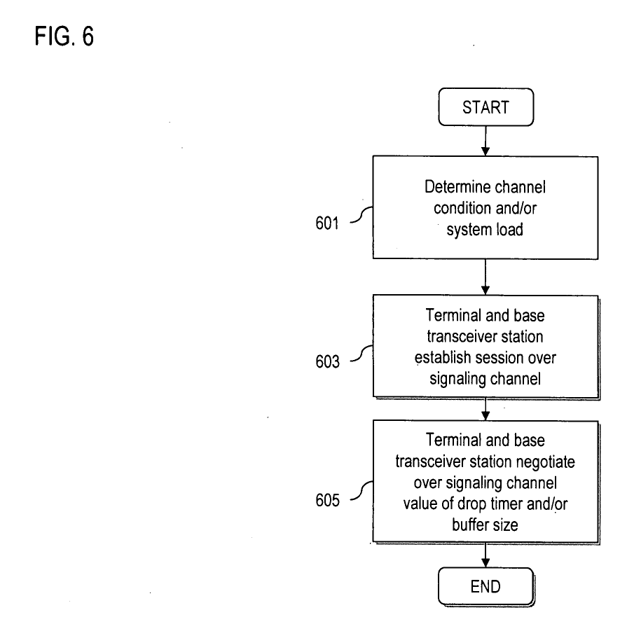

FIG. 6 is a flowchart of a process for signaling in the system of FIG. 1 to negotiate slewing parameters, in accordance with an embodiment of the invention. For the scenario where there is an additional signaling available, a joint decision regarding the size of the drop timer and the jitter buffer can be made. First, the channel condition and/or system load is determined, per step 601. In step 603, the terminal 101 and the base transceiver station 103 establish communication over a signaling channel. Next, the terminal 101 and the base transceiver station 103 negotiate time-warping parameters, such as value of drop timer and/or buffer size, over the signaling channel (step 605).

FIGS. 7A and 7B are flowcharts of processes for minimizing delay during transmission of voice frames on the uplink, according to various embodiments of the invention. These processes involve utilizing an additional criterion for commanding more rapid playout of the buffer 107. The description of this aspect considers that both the speech decoder 111 that receives the voice frames from the forward link, and the speech encoder 121 that sends the voice frames on the reverse link (or uplink) are requested to operate simultaneously (or concurrently) in the terminal 101. The forward link refers to transmissions from the BTS 103 to the terminal 101, and the uplink link refers to transmissions from the terminal 101 to the BTS 103.

When a user is listening to the speech of the other party, the terminal 101 maintains a certain average buffer size for the speech decoder 101. If during this time the user starts talking (i.e., terminal 101 commences sending voice frames on the uplink), wishing to reply or to interrupt the other party, two possible actions can be performed, as shown in FIGS. 7A and 7B.

As seen in FIG. 7A, transmission of voice frames are initiated by the user who begins talking during playout by the speech decoder 111 (step 701), a signal can be sent from the speech encoder 121 to the decision module 109 of the speech decoder 111 to increase the playout rate of the buffer 107. This command reduces the perceived delay, assuming the buffer size is too large.

Alternatively (as shown in FIG. 7B), when the user interrupts or replys to the other party, as in step 711, the voice frames that the speech encoder 121 generates for the uplink are marked with high priority either by the terminal 101 or by the BTS 103 (step 713). This marking can alert the other party of the user's intention to reply or interrupt speech from the other party.

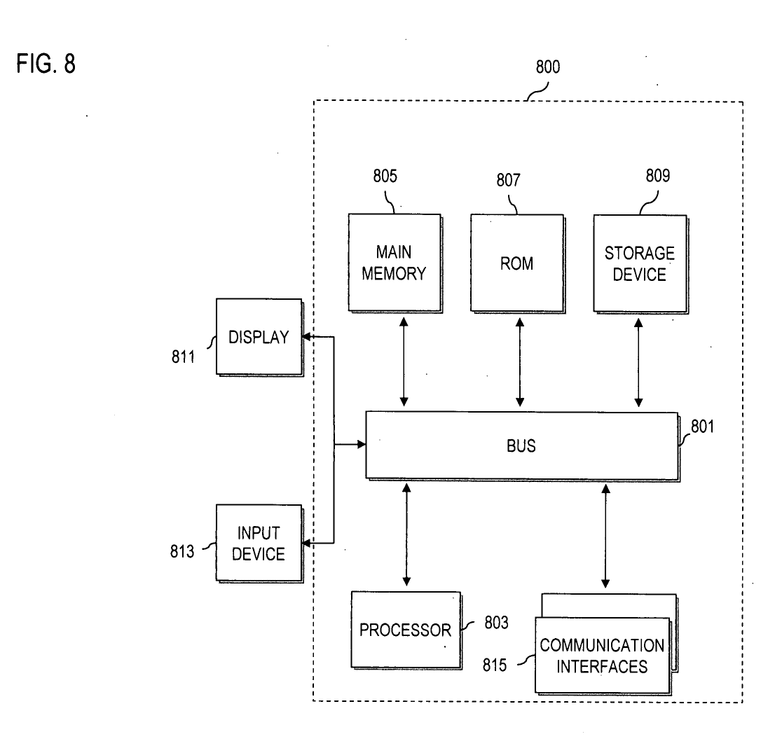

One of ordinary skill in the art would recognize that the processes for providing time-warping of speech via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 8.

FIG. 8 illustrates exemplary hardware upon which various embodiments of the invention can be implemented. A computing system 800 includes a bus 801 or other communication mechanism for communicating information and a processor 803 coupled to the bus 801 for processing information. The computing system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computing system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computing system 800 may be coupled via the bus 801 to a display 811, such as a liquid crystal display, or active matrix display, for displaying information to a user. An input device 813, such as a keyboard including alphanumeric and other keys, may be coupled to the bus 801 for communicating information and command selections to the processor 803. The input device 813 can include a cursor control, such as a mouse, a trackball, or cursor direction keys, for communicating direction information and command selections to the processor 803 and for controlling cursor movement on the display 811.

According to various embodiments of the invention, the processes described herein can be provided by the computing system 800 in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 800 also includes at least one communication interface 815 coupled to bus 801. The communication interface 815 provides a two-way data communication coupling to a network link (not shown). The communication interface 815 sends and receives electrical, electromagnetic, or optical signals that carry digital data streams representing various types of information. Further, the communication interface 815 can include peripheral interface devices, such as a Universal Serial Bus (USB) interface, a PCMCIA (Personal Computer Memory Card International Association) interface, etc.

The processor 803 may execute the transmitted code while being received and/or store the code in the storage device 809, or other non-volatile storage for later execution. In this manner, the computing system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

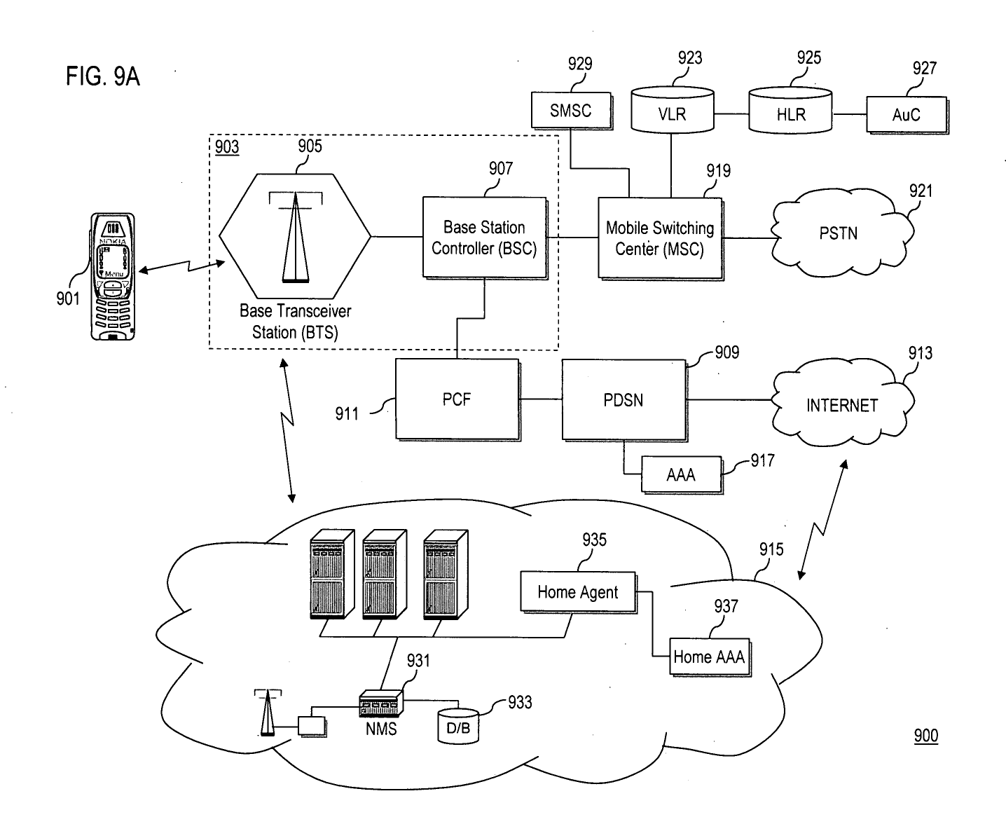

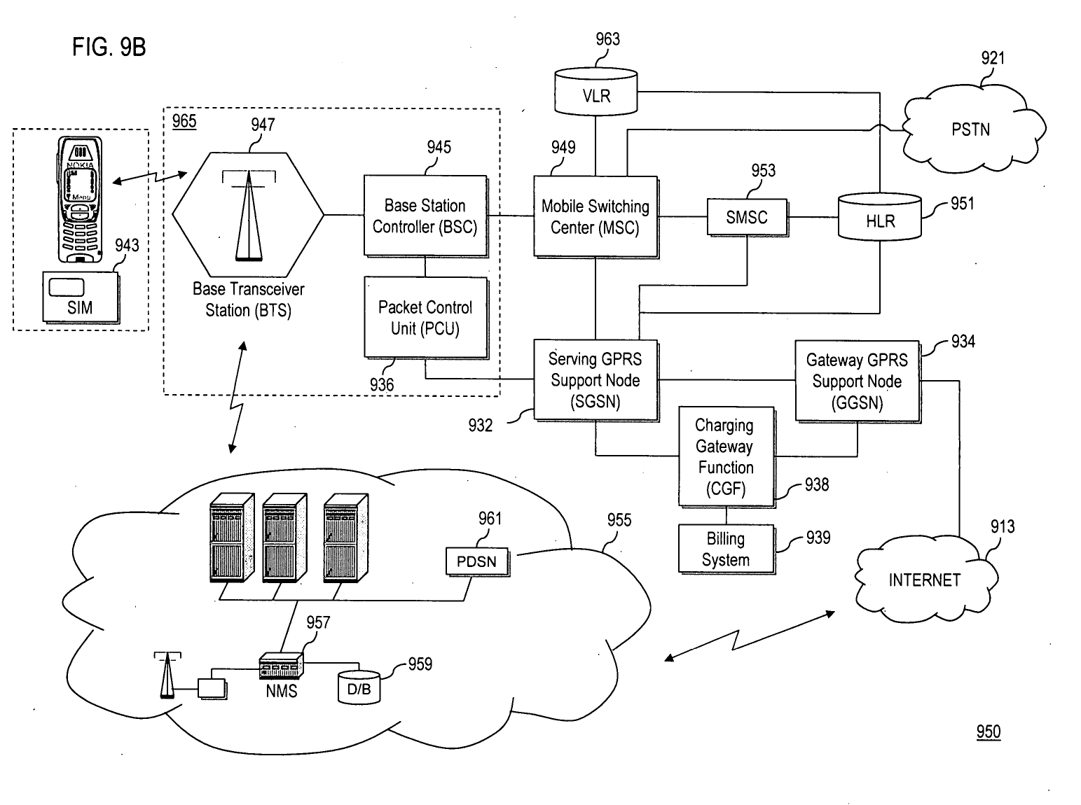

FIGS. 9A and 9B are diagrams of different cellular mobile phone systems capable of supporting various embodiments of the invention. FIGS. 9A and 9B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 900 includes mobile stations 901 (e.g., handsets, terminals, stations, units, devices, or any type of interface to the user (such as “wearable” circuitry, etc.)) in communication with a Base Station Subsystem (BSS) 903. According to one embodiment of the invention, the radio network supports Third Generation (3G) services as defined by the International Telecommunications Union (ITU) for International Mobile Telecommunications 2000 (IMT-2000).

In this example, the BSS 903 includes a Base Transceiver Station (BTS) 905 and Base Station Controller (BSC) 907. Although a single BTS is shown, it is recognized that multiple BTSs are typically connected to the BSC through, for example, point-to-point links. Each BSS 903 is linked to a Packet Data Serving Node (PDSN) 909 through a transmission control entity, or a Packet Control Function (PCF) 911. Since the PDSN 909 serves as a gateway to external networks, e.g., the Internet 913 or other private consumer networks 915, the PDSN 909 can include an Access, Authorization and Accounting system (AAA) 917 to securely determine the identity and privileges of a user and to track each user's activities. The network 915 comprises a Network Management System (NMS) 931 linked to one or more databases 933 that are accessed through a Home Agent (HA) 935 secured by a Home AAA 937.

Although a single BSS 903 is shown, it is recognized that multiple BSSs 903 are typically connected to a Mobile Switching Center (MSC) 919. The MSC 919 provides connectivity to a circuit-switched telephone network, such as the Public Switched Telephone Network (PSTN) 921. Similarly, it is also recognized that the MSC 919 may be connected to other MSCs 919 on the same network 900 and/or to other radio networks. The MSC 919 is generally collocated with a Visitor Location Register (VLR) 923 database that holds temporary information about active subscribers to that MSC 919. The data within the VLR 923 database is to a large extent a copy of the Home Location Register (HLR) 925 database, which stores detailed subscriber service subscription information. In some implementations, the HLR 925 and VLR 923 are the same physical database; however, the HLR 925 can be located at a remote location accessed through, for example, a Signaling System Number 7 (SS7) network. An Authentication Center (AuC) 927 containing subscriber-specific authentication data, such as a secret authentication key, is associated with the HLR 925 for authenticating users. Furthermore, the MSC 919 is connected to a Short Message Service Center (SMSC) 929 that stores and forwards short messages to and from the radio network 900.

During typical operation of the cellular telephone system, BTSs 905 receive and demodulate sets of reverse-link signals from sets of mobile units 901 conducting telephone calls or other communications. Each reverse-link signal received by a given BTS 905 is processed within that station. The resulting data is forwarded to the BSC 907. The BSC 907 provides call resource allocation and mobility management functionality including the orchestration of soft handoffs between BTSs 905. The BSC 907 also routes the received data to the MSC 919, which in turn provides additional routing and/or switching for interface with the PSTN 921. The MSC 919 is also responsible for call setup, call termination, management of inter-MSC handover and supplementary services, and collecting, charging and accounting information. Similarly, the radio network 900 sends forward-link messages. The PSTN 921 interfaces with the MSC 919. The MSC-919 additionally interfaces with the BSC 907, which in turn communicates with the BTSs 905, which modulate and transmit sets of forward-link signals to the sets of mobile units 901.

As shown in FIG. 9B, the two key elements of the General Packet Radio Service (GPRS) infrastructure 950 are the Serving GPRS Supporting Node (SGSN) 932 and the Gateway GPRS Support Node (GGSN) 934. In addition, the GPRS infrastructure includes a Packet Control Unit PCU (1336) and a Charging Gateway Function (CGF) 938 linked to a Billing System 939. A GPRS the Mobile Station (MS) 941 employs a Subscriber Identity Module (SIM) 943.

The PCU 936 is a logical network element responsible for GPRS-related functions such as air interface access control, packet scheduling on the air interface, and packet assembly and re-assembly. Generally the PCU 936 is physically integrated with the BSC 945; however, it can be collocated with a BTS 947 or a SGSN 932. The SGSN 932 provides equivalent functions as the MSC 949 including mobility management, security, and access control functions but in the packet-switched domain. Furthermore, the SGSN 932 has connectivity with the PCU 936 through, for example, a Fame Relay-based interface using the BSS GPRS protocol (BSSGP). Although only one SGSN is shown, it is recognized that that multiple SGSNs 931 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 945, any given BSC 945 generally interfaces with one SGSN 932. Also, the SGSN 932 is optionally connected with the HLR 951 through an SS7-based interface using GPRS enhanced Mobile Application Part (MAP) or with the MSC 949 through an SS7-based interface using Signaling Connection Control Part (SCCP). The SGSN/HLR interface allows the SGSN 932 to provide location updates to the HLR 951 and to retrieve GPRS-related subscription information within the SGSN service area. The SGSN/MSC interface enables coordination between circuit-switched services and packet data services such as paging a subscriber for a voice call. Finally, the SGSN 932 interfaces with a SMSC 953 to enable short messaging functionality over the network 950.

The GGSN 934 is the gateway to external packet data networks, such as the Internet 913 or other private customer networks 955. The network 955 comprises a Network Management System (NMS) 957 linked to one or more databases 959 accessed through a PDSN 961. The GGSN 934 assigns Internet Protocol (IP) addresses and can also authenticate users acting as a Remote Authentication Dial-In User Service host. Firewalls located at the GGSN 934 also perform a firewall function to restrict unauthorized traffic. Although only one GGSN 934 is shown, it is recognized that a given SGSN 932 may interface with one or more GGSNs 933 to allow user data to be tunneled between the two entities as well as to and from the network 950. When external data networks initialize sessions over the GPRS network 950, the GGSN 934 queries the HLR 951 for the SGSN 932 currently serving a MS 941.

The BTS 947 and BSC 945 manage the radio interface, including controlling which Mobile Station (MS) 941 has access to the radio channel at what time. These elements essentially relay messages between the MS 941 and SGSN 932. The SGSN 932 manages communications with an MS 941, sending and receiving data and keeping track of its location. The SGSN 932 also registers the MS 941, authenticates the MS 941, and encrypts data sent to the MS 941.

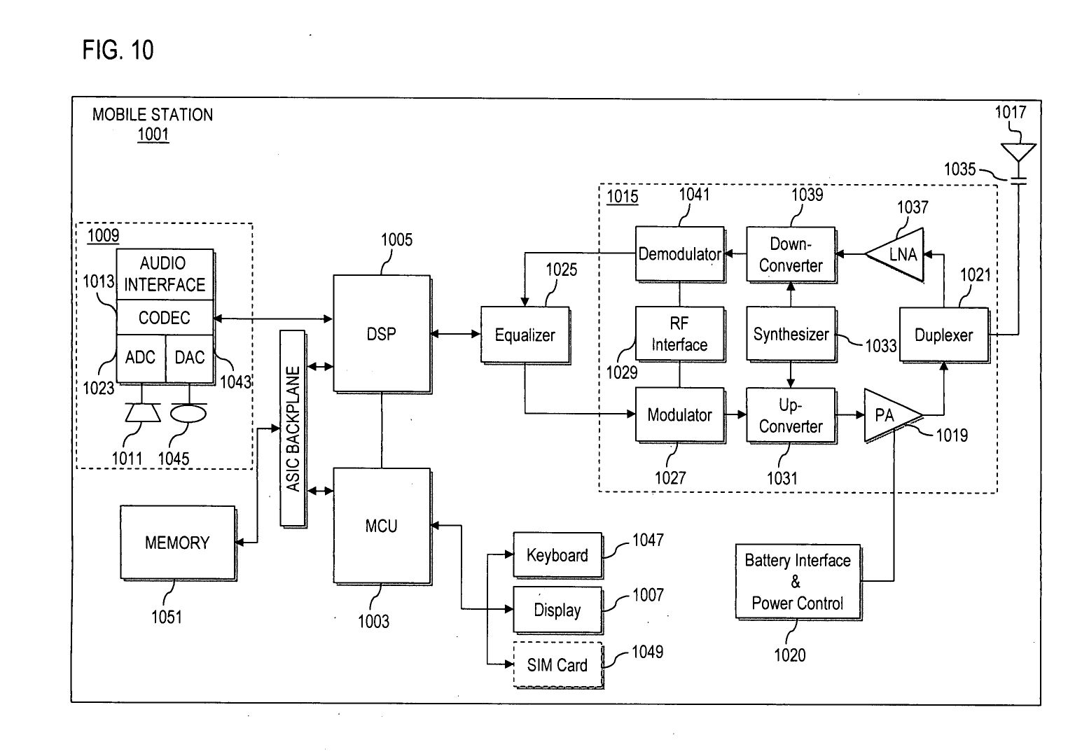

FIG. 10 is a diagram of exemplary components of a mobile station (e.g., handset) capable of operating in the systems of FIGS. 9A and 9B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system (e.g., systems of FIG. 14A or 14B), via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-2000; which is incorporated herein by reference in its entirety.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The MCU 1003 delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

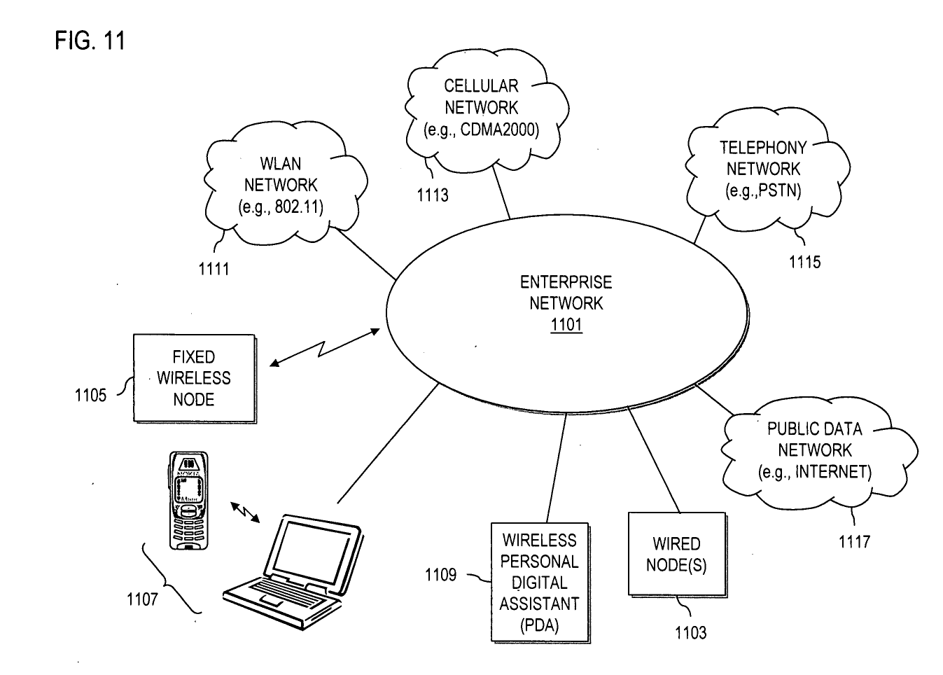

FIG. 11 shows an exemplary enterprise network, which can be any type of data communication network utilizing packet-based and/or cell-based technologies (e.g., Asynchronous Transfer Mode (ATM), Ethernet, IP-based, etc.). The enterprise network 1101 provides connectivity for wired nodes 1103 as well as wireless nodes 1105-1109 (fixed or mobile), which are each configured to perform the processes described above. The enterprise network 1101 can communicate with a variety of other networks, such as a WLAN network 1111 (e.g., IEEE 802.11), a cdma2000 cellular network 1113, a telephony network 1115 (e.g., PSTN), or a public data network 1117 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining whether a condition exists that introduces delay in a communication system; and
dynamically time-warping of a voice frame in response to the determined condition for playout to a user.

2. A method according to claim 1, wherein the condition includes a channel condition, loading of the communication system, or a combination of the channel condition and the loading.

3. A method according to claim 1, wherein the communication system includes a cellular network, the method further comprising:
initiating a handoff procedure within the cellular network, wherein the step of time-warping is performed during the handoff procedure; and
restoring playout rate of voice frames after completion of the handoff procedure.

4. A method according to claim 1, further comprising:
storing voice frames including the voice frame within a playout buffer; and
adjusting the size of the playout buffer.

5. A method according to claim 4, further comprising:
analyzing the voice frame within the playout buffer to determine buffer information including size of the playout buffer, type of the voice frame, or beginning of voice inactivity.

6. A method according to claim 4, further comprising:
monitoring average size of the playout buffer; and
determining whether the average size of the playout buffer is below a threshold to adjust the size of the playout buffer.

7. A method according to claim 4, wherein the condition represents condition of a channel, the method further comprising:
transmitting acknowledgement messages over the channel to a transmitter of the voice frame, the acknowledgement messages corresponding to received voice frames, wherein the condition is determined based on the acknowledgement messages received by the transmitter.

8. A method according to claim 4, further comprising:
receiving a signal from a transmitter of the voice frame to adjust the size of the playout buffer.

9. A method according to claim 1, further comprising:
determining a time-warping parameter associated with the step of dynamically time-warping; and
transmitting the time-warping parameter to a transmitter of the voice frame.

10. A method according to claim 1, wherein the time-warping parameter includes a value of a drop timer specifying when a voice frame stored at the transmitter should be dropped.

11. A method according to claim 1, further comprising:
communicating with a transmitter of the voice frame to negotiate a time-warping parameter associated with the step of dynamically time-warping.

12. A method according to claim 1, further comprising:
initiating transmission of voice frames over an uplink; and
increasing playout rate in response to the step of initiating transmission.

13. A method according to claim 1, further comprising:
initiating transmission of voice frames over an uplink; and
marking the voice frames as priority frames.

14. An apparatus comprising:
a decision module configured to determine whether a condition exists that introduces delay in a communication system; and
a speech decoder configured to dynamically time-warp a voice frame in response to the determined condition for playout to a user.

15. An apparatus according to claim 14, wherein the condition includes a channel condition, loading of the communication system, or a combination of the channel condition and the loading.

16. An apparatus according to claim 14, wherein the communication system includes a cellular network, and the step of time-warping is performed during a handoff procedure, the playout rate of voice frames being restored after completion of the handoff procedure.

17. An apparatus according to claim 14, further comprising:
a playout buffer configured to store voice frames including the voice frame, wherein the size of the playout buffer is adjusted.

18. An apparatus according to claim 17, further comprising:
a queue analyzer configured to analyze the voice frame within the playout buffer to determine buffer information including size of the playout buffer, type of the voice frame, or beginning of voice inactivity.

19. An apparatus according to claim 17, wherein the average size of the playout buffer is monitored, and the size of the playout buffer is adjusted if the average size of the playout buffer is below a threshold.

20. An apparatus according to claim 17, wherein the condition represents condition of a channel, the method further comprising:
means for transmitting acknowledgement messages over the channel to a transmitter of the voice frame, the acknowledgement messages corresponding to received voice frames, wherein the condition is determined based on the acknowledgement messages received by the transmitter.

21. An apparatus according to claim 17, further comprising:
means for receiving a signal from a transmitter of the voice frame to adjust the size of the playout buffer.

22. An apparatus according to claim 14, further comprising:
a decision module configured to determine a time-warping parameter for dynamically time-warping the voice frame, wherein the time-warping parameter to a transmitter of the voice frame.

23. An apparatus according to claim 14, wherein the time-warping parameter includes a value of a drop timer specifying when a voice frame stored at the transmitter should be dropped.

24. An apparatus according to claim 14, further comprising:
a transceiver configured to communicate with a transmitter of the voice frame to negotiate a time-warping parameter associated with the step of dynamically time-warping.

25. An apparatus according to claim 14, further comprising:
a speech encoder configured to send a signal to the decision module to increase playout rate in response to initiation of transmission of voice frames over an uplink.

26. An apparatus according to claim 14, wherein the decision module is configured to mark the voice frames as priority frames in response to initiation of transmission of voice frames over an uplink.

27. A system comprising the apparatus of claim 14, the system comprising:
a keyboard configured to receive input from the user; and
a display configured to display the input.

28. A method comprising:
receiving a time-warping parameter over a communication system from a terminal for time-warping of speech, wherein the time-warping parameter is determined by the terminal based on channel condition of the communication or loading of the communication system, the terminal dynamically adjusting playout of the speech in response to the channel condition or the loading; and
modifying scheduling of voice frames representing speech according to the time-warping parameter.

29. A method according to claim 28, wherein the communication system includes a cellular network, and the time-warping parameter is generated during a handoff procedure within the cellular network.

30. A method according to claim 28, wherein the time-warping parameter includes a value of a drop timer specifying when a voice frame should be dropped.

31. A method according to claim 28, further comprising:
communicating with the terminal to negotiate the time-warping parameter.

32. A method according to claim 28, further comprising: receiving voice frames over an uplink from the terminal, wherein the voice frames are marked by the terminal as priority frames.

33. A method according to claim 28, wherein the voice frames include packetized data representing audio information.

34. An apparatus comprising:
a transceiver configured to receive a time-warping parameter over a communication system from a terminal for time-warping of speech, wherein the time-warping parameter is determined by the terminal based on channel condition of the communication or loading of the communication system, the terminal dynamically adjusting playout of the speech in response to the channel condition or the loading; and
a scheduler configured to schedule voice frames representing speech for transmission to the terminal, wherein scheduling of voice frames is modified according to the time-warping parameter.

35. An apparatus according to claim 34, wherein the communication system includes a cellular network, and the time-warping parameter is generated during a handoff procedure within the cellular network.

36. An apparatus according to claim 34, further comprising:
a drop timer configured to indicate when a voice frame should be dropped, wherein the time-warping parameter includes a drop timer value.

37. An apparatus according to claim 34, wherein the time-warping parameter is negotiated with the terminal.

38. An apparatus according to claim 34, wherein the transceiver is further configured to receive voice frames over an uplink from the terminal, and the voice frames are marked by the terminal as priority frames.

39. An apparatus according to claim 34, wherein the voice frames include packetized data representing audio information.

40. A system comprising the apparatus of claim 34.
